(19) United States
(12) Patent Application Publication
(10) Pub. No.: US 2018/0240346 A1
(43) Pub. Date: Aug. 23, 2018

(54) EXPLORATION SYSTEM

(71) Applicant: Hitachi, Ltd., Tokyo (JP)

(72) Inventors: Akira MAEKI, Tokyo (JP); Yoshio SUMITANI, Tokyo (JP); Kenji FUJIHIRA, Tokyo (JP)

(21) Appl. No.: 15/752,973

(22) PCT Filed: Nov. 20, 2015
(86) PCT No.: PCT/JP2015/082715

§ 371 Date: Feb. 15, 2018

(51) Int. Cl. G08G 1/00; G08G 1/127; G05D 1/02

(52) U.S. Cl. CPC G08G 1/20; G08G 1/22; G05D 1/0295; G05D 1/0297; G08G 1/127

(57) ABSTRACT

Provided is an exploration system comprising a plurality of vibration generating vehicles, wherein resource exploration is performed by a vibration generating action by a group of vibration generating vehicles constituted by the plurality of vibration generating vehicles, each of the plurality of vibration generating vehicles of the group of vibration generating vehicles is provided with: a storage unit in which vibration location information related to a vibration location in a vibration by the group of vibration generating vehicles is stored in association with the group of vibration generating vehicles; an exploration unit that performs a vibration generating action for exploration; a control unit that controls movement of the vibration generating vehicle; and a calculation unit that obtains location information from the storage unit, instructs movement to the control unit on the basis of the obtained location information and instructs a vibration generating action to the exploration unit after the movement.

### TECHNICAL FIELD

The present invention relates to an exploration system.

### BACKGROUND ART

A large-sized reservoirs (petroleum reservoirs), which were easy to extract, has already been discovered and developed. Henceforth, exploration at a deeper depth and in a complex stratum is required. Meanwhile, improvement of sensor sensitivity or large-scale exploration on a ground surface depending on the depth is indispensable for exploration of these areas. The market requires both a system that implements these requirements and a low-cost operation.

A method referred to as physical exploration or reflection seismic exploration is present as a scheme widely used in resource exploration. In principle, elastic waves generated by an artificial seismic source (such as a dynamite, a vibration generating vehicle that vibrates the ground, etc.) are reflected at an interface of a stratum, for example, an interface of a petroleum layer, gas layer, water, a rock layer, etc., reflected waves returning to the ground surface are received by a plurality of sensors installed on the ground surface or a borehole, and a reservoir layer image is constructed from data of these reflected waves.

A vibration generating vehicle (also referred to as a vibrator, etc.) that vibrates the ground is widely used as the artificial seismic source. However, to obtain a clearer underground stratum structure, a group of vibration generating vehicles, in which a plurality of (four or five) units is set as one group, ensures necessary energy by vibrating the ground while synchronizing.

With regard to such a vibration generating vehicle, PTL 1 discloses a technology “capable of accurately sweeping a vibration of a vibrator of each artificial seismic source device in the same phase in a geological structure survey using a plurality of artificial seismic source devices”.

### CITATION LIST

### Patent Literature

PTL1: Japanese Patent Publication No.04-188091

### SUMMARY OF THE INVENTION

### Technical Problem

When the technology disclosed in PTL 1 is applied, it is possible to obtain large vibration energy from the plurality of vibration generating vehicles. However, there is no mention of a technology related to arrangement of the plurality of vibration generating vehicles at points of vibration.

In a group of vibration generating vehicles that forms a line to repeat movement and vibration generation, when a driver of each vibration generating vehicle drives it to a target point of vibration, the line of the vehicles may not accurately arrive at a desired location or it takes more time than necessary even when the line arrives at the desired location due to poor visibility resulting from dust assumed in a desert, lack of driving skills, or a decrease in attention and judgment resulting from monotonous work or late night work. In addition, in the case of resource exploration, in particular, large-scale exploration, there is a case in which an operation is performed on a 24-hour basis for several months in a remote place (desert, etc.) away from a center of a city, and labor costs of drivers and burden become large considering shift work.

In this regard, an object of the invention is to provide a technology of disposing a plurality vibration generating vehicles at respective points of vibration.

### Solutions to Problems

A representative exploration system according to the invention is an exploration system including a plurality of vibration generating vehicles, in which resource exploration is performed by a vibration by a group of vibration generating vehicles including the plurality of vibration generating vehicles, and each of the plurality of vibration generating vehicles of the group of vibration generating vehicles includes a storage unit in which vibration location information related to a vibration location in a vibration by the group of vibration generating vehicles is stored in association with the group of vibration generating vehicles, an exploration unit that performs a vibration generating action for exploration, a control unit that controls movement of each of the vibration generating vehicles, and a processing unit that obtains the location information from the storage unit, instructs the control unit to move based on the obtained location information, and instructs the exploration unit to perform the vibration generating action after movement.

### Advantageous Effects of the Invention

According to the invention, it is possible to dispose a plurality vibration generating vehicles at respective points of vibration at high efficiency and high accuracy.

### BRIEF DESCRIPTION OF THE DRAWINGS

FIG. 1 is a diagram illustrating an example of resource exploration.

FIG. 2 is a diagram illustrating an example of a vibration generating vehicle using an absolute location.

FIG. 3 is a diagram illustrating an example of a vibration generation management table including the absolute location.

FIG. 4 is a flowchart illustrating an example of control of the vibration generating vehicle.

FIG. 5 is a diagram illustrating an example a vibration generating vehicle additionally using a relative location.

FIG. 6 is a diagram illustrating an example of a vibration generation management table additionally including the relative location.

FIG. 7 is a diagram illustrating an example of a vibration generation schedule table.

FIG. 8 is a diagram illustrating an example of a type of a group of vibration generating vehicles.

### DESCRIPTION OF EMBODIMENTS

Hereinafter, each of embodiments will be described with reference to drawings.

### Embodiment 1

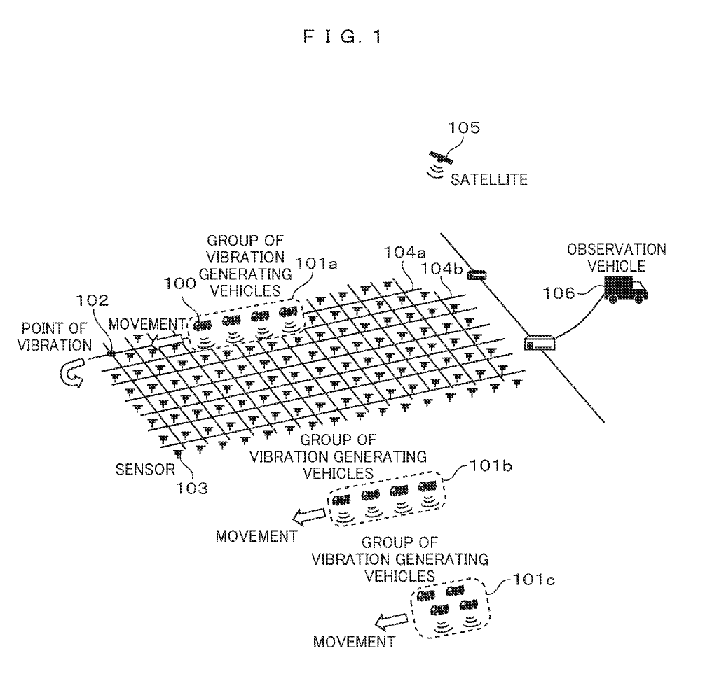

FIG. 1 is a diagram illustrating an example of resource exploration. The figure illustrates a simplified configuration to describe a point of the invention. However, a sensor or a point of vibration may not be arranged in an orderly manner as in the figure due to a design policy on the point of vibration or various factors in a field. A plurality of vibration generating vehicles 100 forms one group and becomes a group of vibration generating vehicles 101a to move to a point of vibration 102 and generate vibration. For example, the group of vibration generating vehicles 101a may include four vibration generating vehicles 100. In FIG. 1, only one point of vibration 102 is illustrated as a point of vibration. However, all intersections of a lattice illustrated in FIG. 1 may correspond to the point of vibration. For this reason, the group of vibration generating vehicles 101a generates vibration at the point of vibration corresponding to each intersection of the lattice while moving straight on a movement path 104a.

Upon moving to the point of vibration 102 and generating vibration, the group of vibration generating vehicles 101a makes a U-turn and generates vibration while moving on a movement path 104b. In this way, the group of vibration generating vehicles 101a generates vibration at a point of vibration set in advance, for example, all the intersection of the lattice illustrated in FIG. 1 by repeating straight movement and a U-turn. For example, the points of vibration are set at a certain interval determined in advance such as 10 m. For example, a location of the point of vibration is detected by a global positioning system (GPS) signal, etc. from a satellite 105.

For example, points of vibration at 100 thousand places, etc. are set according to a region of an exploration target area, etc. For this reason, when the vibration generating vehicle corresponds to manned driving, a driver of the vibration generating vehicle needs to operate the group of vibration generating vehicles on a 24-hour basis for several months on three shifts. In addition, since the number of points of vibration is large, the exploration target area may be divided into a plurality of parts using a plurality of groups of vibration generating vehicles 101 such as a group of vibration generating vehicles 101b in addition to the group of vibration generating vehicles 101a (described as a group of vibration generating vehicles 101 when one of the group of vibration generating vehicles 101a and the group of vibration generating vehicles 101b is not specified, other reference symbols are described in the same manner), and exploration may be performed at the same time.

When a distance between the group of vibration generating vehicles 101a and the group of vibration generating vehicles 101b is short, vibration generation timing may be shifted. For example, the group of vibration generating vehicles 101b may generate vibration while the group of vibration generating vehicles 101a moves. In addition, for example, a plurality of rows such as two rows may be formed as in a group of vibration generating vehicles 101c. Depending on the density of the exploration target area or the points of vibration, two groups of vibration generating vehicles 101 in two rows rather than four groups of vibration generating vehicles 101 in one row may correspond to a preferred embodiment in some cases.

A vibration caused by vibration generation of the group of vibration generating vehicles 101 is reflected by a boundary surface between a stratum such as a rock layer and a reservoir in which oil or gas is reserved, etc. and detected by the sensor 103. A signal of a reflected wave detected by the sensor is collected and analyzed by an observation vehicle 106. A plurality of sensors 103 is disposed as illustrated in FIG. 1. However, here, a detailed description will be omitted. However, the sensor 103 may be disposed in an area overlapping a movement path 104 of the group of vibration generating vehicles 101, and a control operation may be performed such that the group of vibration generating vehicles 101 does not step on the sensor 103. The exploration target area may correspond to a desert. In the case of the desert, the movement path 104 may be set to a substantially straight line. However, the exploration target area is not limited to the desert and may correspond to an urban area, etc.

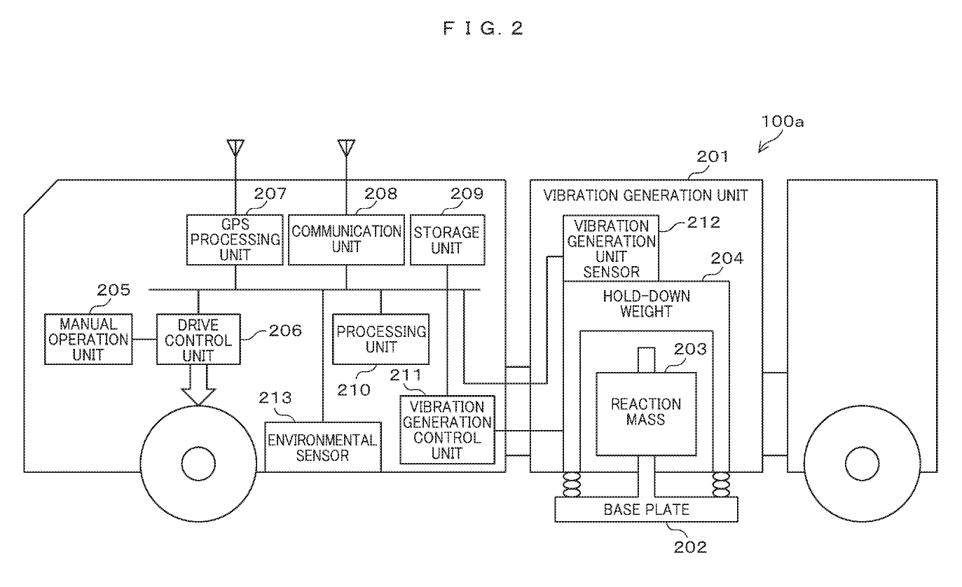

FIG. 2 is a diagram illustrating an example of the vibration generating vehicle. A vibration generating vehicle 100a illustrated in FIG. 2 corresponds to an example of the vibration generating vehicle 100 illustrated in FIG. 1. The vibration generating vehicle 100a includes a vibration generation unit 201. A hold-down weight 204 presses a base plate 202 to the ground surface such that vibration is allowed at the time of generating vibration, and the base plate 202 vibrates by reaction of movement of a reaction mass 203. When the vibration generating vehicle 100a moves, pressing of the hold-down weight 204 is released, and the base plate 202 is separated from the ground surface.

A manual operation unit 205 corresponds to a steering wheel, an accelerator pedal, a brake pedal, etc. operated by the driver. Information operated by the manual operation unit 205 may be transmitted to a drive control unit 206 and used to control a direction of a tire, an engine, the brake, etc. Alternatively, the direction of the tire, the engine, the brake, etc. may be mechanically operated from the manual operation unit 205 without the drive control unit 206 interposed therebetween. Alternatively, the vibration generating vehicle 100a may not include the manual operation unit 205, and may correspond to an unmanned vehicle.

The drive control unit 206 controls the direction of the tire, the engine, the brake, etc. according to an instruction from a processing unit 210, etc. When the vibration generating vehicle 100a includes the manual operation unit 205, for example, the drive control unit 206 may perform a control operation such that an instruction from the processing unit 210, etc. has priority in movement near the point of vibration 102, and perform a control operation such that information from the manual operation unit 205 has priority in movement between points of vibration away from the point of vibration 102. In this way, a control operation may be performed such that accuracy of a stop location at the point of vibration 102 is improved. In addition, a control operation may be performed such that the information from the manual operation unit 205 has priority at all times.

A GPS processing unit 207 receives a GPS signal from the satellite 105 and obtains an absolute location of the vibration generating vehicle 100a. For example, the absolute location may correspond to longitude, latitude, etc. Information about the obtained absolute location may be transmitted to the processing unit 210 and processed. A communication unit 208 communicates with another vibration generating vehicle 100, communicates with the observation vehicle 106, communicates with a base such as a base camp (not illustrated), and communicates with a remote place through the satellite 105. Information transmitted and received by communication of the communication unit 208 may be processed by the processing unit 210.

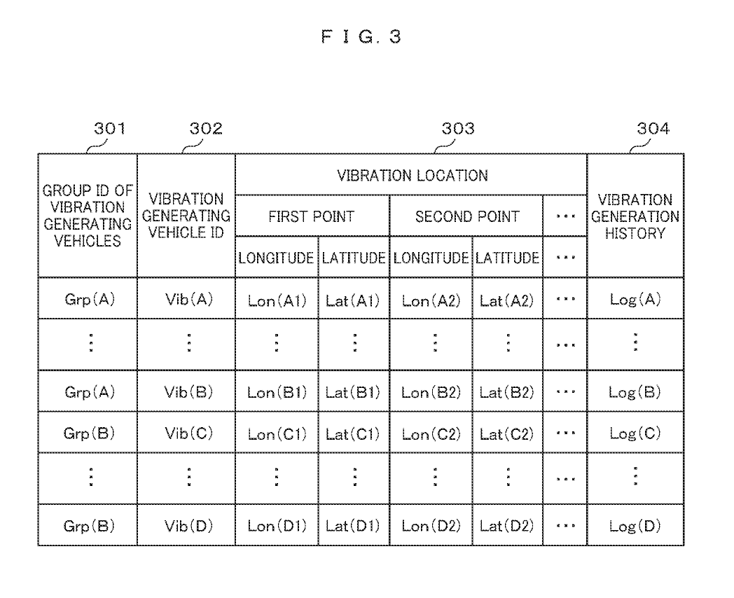

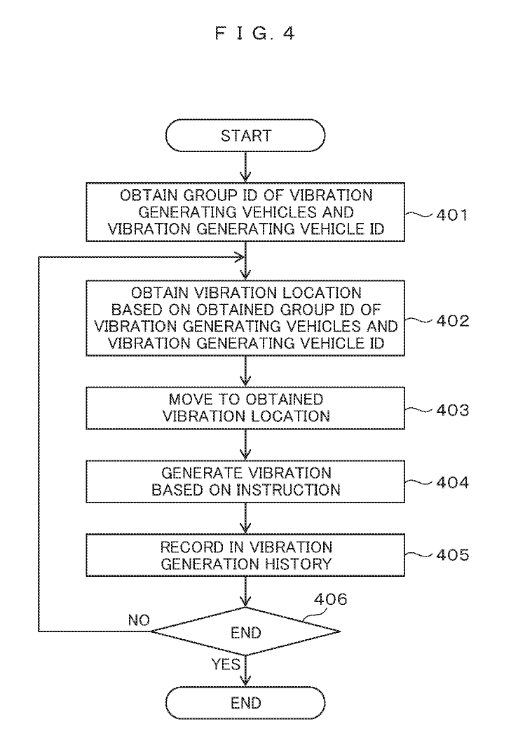

For example, information related to a location of movement, information related to vibration generation, and information related to the vibration generating vehicle 100a are stored in a storage unit 209, and a vibration generation management table may be stored therein. The vibration generation management table will be described below with reference to FIG. 3. In addition, a program or data necessary for processing of the processing unit 210 may be stored, and a program of vibration generating vehicle control may be stored. A process flow of the vibration generating vehicle control will be described below with reference to FIG. 4.

For example, the processing unit 210 corresponds to a computer or a processor, and executes processing by communicating with each unit in the vibration generating vehicle 100a. For example, the program stored in the storage unit 209 or the information related to the vibration generating vehicle 100a may be read, information about the absolute location obtained by the GPS processing unit 207 or information communicated by the communication unit 208 may be received, and information detected by a vibration generation unit sensor 212 or an environmental sensor 213 may be received. In addition, an instruction may be output to the drive control unit 206 or a vibration generation control unit 211.

The vibration generation unit sensor 212 is a sensor that detects a state of the vibration generation unit 201. For example, information on a vibration generation state or a state related to deterioration of the vibration generation unit 201 such as the number of times of vibration generation, strength of vibration, a repulsive force from the ground surface, etc. may be included as the state of the vibration generation unit 201. The environmental sensor 213 is a sensor that detects a surrounding state of the vibration generating vehicle 100a. Examples of the surrounding state may include a state related to vehicle deterioration of the vibration generation unit 201 or the vibration generating vehicle 100a such as temperature, humidity, strength or component of soil, etc.

Respective units in the vibration generating vehicle 100a may be connected by an in-vehicle local area network (LAN). For example, the in-vehicle LAN may correspond to a controller area network (CAN), a local interconnect network (LIN), etc. In addition, when the vibration generating vehicle 100a has the in-vehicle LAN as the vehicle, the in-vehicle LAN may be used.

FIG. 3 is a diagram illustrating an example of the vibration generation management table. The vibration generation management table may be stored in the storage unit 209 of the vibration generating vehicle 100a. The vibration generation management table has a group ID of vibration generating vehicles 301 corresponding to information for identifying the group of vibration generating vehicles 101 and a vibration generating vehicle ID 302 corresponding to information for identifying the vibration generating vehicle 100. For example, it is shown that two vibration generating vehicles 100 whose information about the vibration generating vehicle ID 302 is identified by “Vib(A)” and “Vib(B)” belong to one group of vibration generating vehicles 101 whose group ID of vibration generating vehicles 301 is identified by “Grp(A)”. Information of each of the group ID of vibration generating vehicles 301 and the vibration generating vehicle ID 302 may correspond to an arbitrary identifiable name, and information about the vibration generating vehicle ID 302 may correspond to a communication address of the communication unit 208, etc.

The vibration generation management table has information about a vibration location 303 indicating a location of the point of vibration 102 to be vibrated set in advance. The vibration location 303 has information about locations of a plurality of points of vibration 102, and information about each of the locations may correspond to information about longitude and latitude as an absolute location or information indicating another absolute location.

In addition, the vibration location 303 may include an order of the points of vibration 102. For example, it may be shown that the vibration generating vehicle 100 whose vibration generating vehicle ID 302 corresponds to “Vib(A)” generates vibration at a point of vibration 102 corresponding to longitude of “Lon(A1)” and latitude of “Lat(A1)”, and subsequently generates vibration at a point of vibration 102 corresponding to longitude of “Lon(A2)” and latitude of “Lat(A2)”.

In addition, in the example of FIG. 3, information about the vibration location 303 is associated with information about the vibration generating vehicle ID 302. However, the information about the vibration location 303 may be associated with information about the group ID of vibration generating vehicles 301. For example, with regard to the group of vibration generating vehicles 101 whose group ID of vibration generating vehicles 301 corresponds to “Grp(A)”, the vibration location 303 may be managed such that longitude starts from “Lon(A1)” and latitude starts from “Lat(A1)”, and longitude of “Lon(A2)” and latitude of “Lat(A2)” are subsequent to longitude of “Lon(B1)” and latitude of “Lat(B1)”. In this way, a vibration generating vehicle 100 corresponding to certain longitude and certain latitude may be determined based on an order of information.

For example, when the group of vibration generating vehicles 101 includes four vibration generating vehicles 100, first longitude and latitude may be determined to be information about a first vibration generating vehicle 100, fourth longitude and latitude may be determined to be information about a fourth vibration generating vehicle 100, and fifth longitude and latitude may be determined to be information about the first vibration generating vehicle 100.

The vibration generation management table has a vibration generation history 304 in which information at a time at which vibration is generated is recorded. For example, the vibration generation history 304 may include information about a state detected by the vibration generation unit sensor 212 or the environmental sensor 213 at each point of vibration 102 or include information about the absolute location obtained by the GPS processing unit 207 at a time at which vibration is generated. When vibration is generated at a location shifted from information about the vibration location 303 due to an obstacle, etc., information about an absolute location in the vibration generation history 304 may be used.

In the vibration generation management table illustrated in FIG. 3, the storage unit 209 of the vibration generating vehicle 100a may store only information in which the vibration generating vehicle ID 302 corresponds to the vibration generating vehicle 100a, store only information in which the group ID of vibration generating vehicles 301 corresponds to the group of vibration generating vehicles 101 to which the vibration generating vehicle 100a belongs, or store only information about all the groups of vibration generating vehicles 101.

In addition, in the vibration generation management table illustrated in FIG. 3, the storage unit 209 of the vibration generating vehicle 100a may store only information in which the vibration generating vehicle ID 302 corresponds to the vibration generating vehicle 100a as the vibration generation history 304. Further, the vibration generation management table may not have the group ID of vibration generating vehicles 301 and may not have the vibration generating vehicle ID 302.

FIG. 4 is a flowchart illustrating an example of control of the vibration generating vehicle. For example, the vibration generation management table described with reference to FIG. 3 is stored in advance in the storage unit 209 of the vibration generating vehicle 100a through the communication unit 208 or an input unit (not illustrated). In addition, information about the vibration generating vehicle ID of the vibration generating vehicle 100a and information about an ID of a group of vibration generating vehicles to which the vehicle belongs may be stored in advance in the storage unit 209, etc.

When processing starts, first, the processing unit 210 obtains information about a group ID of vibration generating vehicles and information about a vibration generating vehicle ID of the vibration generating vehicle 100a stored in advance (step 401). The processing unit 210 retrieves information in which the obtained information about the group ID of vibration generating vehicles and information about the vibration generating vehicle ID match the group ID of vibration generating vehicles 301 and the vibration generating vehicle ID 302 of the vibration generation management table, and obtains longitude and latitude of the vibration location 303 of the retrieved information (step 402). Here, count information of “1” may be stored in advance in the vibration generation history 304, and the count information may be incremented each time the processing unit 210 obtains longitude and latitude in step 402, thereby specifying longitude and latitude obtained in the vibration location 303.

The processing unit 210 compares the longitude and the latitude obtained in step 402 with the longitude and the latitude obtained by the GPS processing unit 207, outputs an instruction to the drive control unit 206, and performs a control operation such that the vibration generating vehicle 100a moves to the longitude and the latitude obtained in step 402 (step 403). In this control operation, longitude and latitude may be obtained by the GPS processing unit 207 for each time and movement distance set in advance to correct a movement instruction.

When the longitude and the latitude obtained in step 402 and the longitude and the latitude obtained by the GPS processing unit 207 fall within preset errors, the processing unit 210 issues an instruction to the drive control unit 206 to stop the vibration generating vehicle 100a, and instructs the vibration generation control unit 211 to generate vibration in response to a vibration generation instruction (step 404). In step 403, the processing unit 210 may transmit information that the vibration generating vehicle 100a has stopped by the communication unit 208.

The processing unit 210 obtains information from the vibration generation unit sensor 212 and the environmental sensor 213, and stores information in the vibration generation management table of the storage unit 209 as information of the vibration generation history 304 (step 405). The processing unit 210 may store the longitude and the latitude obtained from the GPS processing unit 207 as the information of the vibration generation history 304, and omit step 405.

The processing unit 210 determines whether step 404 has been executed at all longitudes and latitudes included in the vibration location 303 (step 406). The processing unit 210 ends the processing when it is determined that step 404 has been executed at all the longitudes and latitudes, and returns to step 402 otherwise.

As described above, each vibration generating vehicle 100 belonging to the group of vibration generating vehicles 101 has information about a vibration location may autonomously move to the point of vibration 102. In addition, each vibration generating vehicle 100 may assist the driver of the vibration generating vehicle 100. For this reason, when the number of points of vibration 102 is enormous, it is possible to reduce burden on an operator involved in resource exploration such as the driver.

### Embodiment 2

In Embodiment 1, a description has been particularly given of a configuration in which each vibration generating vehicle 100a has the vibration generation management table. However, an embodiment of the invention is not limited to this configuration. In Embodiment 2, a description will be given of a configuration in which one vibration generating vehicle 100a (hereinafter referred to as a representative vibration generating vehicle 100a) in a group of vibration generating vehicles 101 has a vibration generation management table, and information about the vibration generation management table is distributed to other vibration generating vehicles 100a.

A configuration of the vibration generating vehicle 100a is the same as the configuration described with reference to FIG. 2. However, information stored in a storage unit 209 is different. Information about a group ID of vibration generating vehicles 301, a vibration generating vehicle ID 302, and a vibration location 303 is stored in a storage unit 209 of the representative vibration generating vehicle 100a and is not stored in storage units 209 of the other vibration generating vehicles 100a. In addition, a communication unit 208 of the representative vibration generating vehicle 100a particularly has a configuration to communicate with communication units 208 of the other vibration generating vehicles 100a.

The information about the vibration generation management table is the same as the information described with reference to FIG. 3. However, the information includes information about all vibration generating vehicles 100a (all vibration generating vehicles whose vibration generating vehicle ID 302 corresponds to “Vib(A)” to “Vib(B)”) of a group of vibration generating vehicles 101 (a group ID of vibration generating vehicles 301 corresponds to “Grp(A)”) to which the representative vibration generating vehicle 100a (for example, a vibration generating vehicle ID 302 corresponds to “Vib(A)”) belongs.

Information about another group of vibration generating vehicles 101 may or may not be included as a vibration generating vehicle management table. When the information about the other group of vibration generating vehicles 101 is not included, information about the group ID of vibration generating vehicles 301 may not be included. In addition, information about the vibration generating vehicle ID 302 of the representative vibration generating vehicle 100a may be used as information representing the group of vibration generating vehicles 101 instead of the information about the group ID of vibration generating vehicles 301.

Vibration generating vehicle control of the representative vibration generating vehicle 100a is the same as the control of the vibration generating vehicle described with reference to FIG. 4. However, in step 402, the processing unit 210 transmits the obtained information about the vibration location to another vibration generating vehicle 100a through the communication unit 208. In this transmission, the information about the vibration generating vehicle ID 302 of the vibration generating vehicle 100a corresponding to a transmission destination and information about longitude and latitude of the vibration location 303 may be combined and transmitted. Vibration generation control of a vibration generating vehicle 100a other than the representative vibration generating vehicle 100a is the same the control of the vibration generating vehicle described with reference to FIG. 4. However, in step 402, the processing unit 210 receives information about the vibration location through the communication unit 208.

In addition, in step 405, a processing unit 210 of a vibration generating vehicle 100a other than the representative vibration generating vehicle 100a may store information about a vibration generation history in a storage unit 209 thereof or transmit the information to the representative vibration generating vehicle 100a through the communication unit 208. When the information is transmitted to the representative vibration generating vehicle 100a, a processing unit 210 of the representative vibration generating vehicle 100a may receive the information through the communication unit 208 and store the information as information about a vibration generation history 304 in a storage unit 209.

As described above, the information about the vibration generation management table may be managed by the one representative vibration generating vehicle 100a. In this way, even when the point of vibration 102 needs to be changed in the middle according to a situation of exploration, an intermediate result, etc., the point may be easily changed by writing new information to one vibration generation management table.

### Embodiment 3

In Embodiment 2, a description has been given of the configuration in which the representative vibration generating vehicle 100a has the vibration generation management table. However, an embodiment of the invention is not limited to this configuration. In Embodiment 3, a description will be given of an example of a configuration in which a component other than the vibration generating vehicle 100a has a vibration generation management table, and information about the vibration generation management table is distributed to each vibration generating vehicle 100a of a group of vibration generating vehicles 101.

For example, the vibration generation management table may be included in a management device of a base camp (not illustrated in FIG. 1) which can directly communicate with a communication unit 208 of the vibration generating vehicle 100a or included in a management device which is far away from the vibration generating vehicle 100a and thus performs communication through a satellite 105.

A configuration of the vibration generating vehicle 100a is the same as the configuration described with reference to FIG. 2. However, information stored in a storage unit 209 is different, and information about a vibration generation management table is not stored in the storage unit 209 of the vibration generating vehicle 100a. In addition, a communication unit 208 particularly has a configuration to communicate with a management device having a vibration generation management table.

Control of a vibration generating vehicle is the same as the control of the vibration generating vehicle 100a other than the representative vibration generating vehicle 100a in Embodiment 2 described with reference to FIG. 4. That is, in step 402, a processing unit 210 of the vibration generating vehicle 100a receives information about a vibration location through the communication unit 208. In addition, in step 405, the processing unit 210 of the vibration generating vehicle 100a may store information about a vibration generation history in a storage unit 209 thereof or transmit the information to the management device through the communication unit 208.

Information about the vibration generation management table is the same as the information described with reference to FIG. 3. Information about a vibration location of the vibration generation management table is transmitted to each vibration generating vehicle 100a by a management device (not illustrated). The vibration generating vehicle 100a may transmit the information about the vibration generation history to the management device in step 405. Upon receiving the information about the vibration generation history, the management device may transmit information about a subsequent vibration location. In addition, the management device may transmit information that allows each vibration generating vehicle 100a to determine ending in step 406 to each vibration generating vehicle 100a.

Further, the vibration generating vehicle 100a may transmit information related to each execution to the management device each time each step described with reference to FIG. 4 is executed, and transmit an absolute location obtained by a GPS processing unit 207 to the management device at an interval set in advance in step 403. In addition, the representative vibration generating vehicle 100a may communicate with the management device, and a vibration generating vehicle 100a other than the representative vibration generating vehicle 100a may communicate with the management device through the representative vibration generating vehicle 100a. In this way, a communication unit 208 of the vibration generating vehicle 100a other than the representative vibration generating vehicle 100a may correspond to an inexpensive communication line capable of communicating with the representative vibration generating vehicle 100a.

As described above, the information about the vibration generation management table may be managed by the management device away from the vibration generating vehicle 100a. In addition, the information about the vibration generation history including a location of the vibration generating vehicle 100a in the middle of movement may be collected by the management device. In this way, even in a case in which an exploration target area is in a harsh environment such as a desert and the point of vibration 102 needs to be changed in the middle according to a situation of exploration, an intermediate result, etc. or in a case in which an operating situation of the vibration generating vehicle 100a is successively monitored, the operator may perform an operation in a place having a favorable environment.

### Embodiment 4

In Embodiments 1 to 3, a description has been given of an example of the vibration generating vehicle 100 that obtains the absolute location using the GPS processing unit 207. In Embodiment 4, a description will be given of an example of a vibration generating vehicle 100b that additionally obtains a relative location. For example, the relative location may correspond to a positional relationship with respect to a preceding vehicle or a subsequent vehicle in a line of a group of vibration generating vehicles 101. One group of vibration generating vehicles 101 may include the vibration generating vehicle 100a and the vibration generating vehicle 100b.

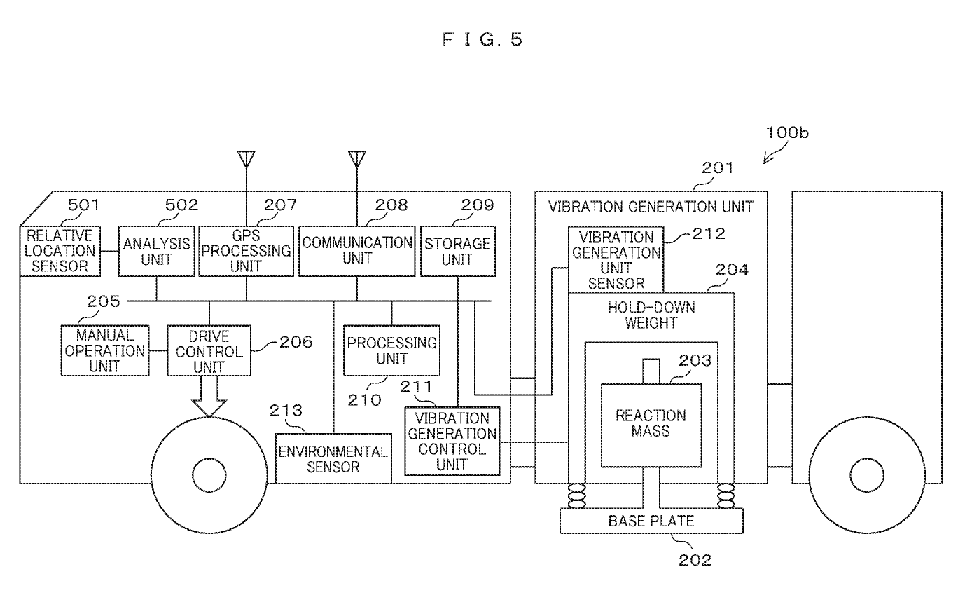

FIG. 5 is a diagram illustrating an example of the vibration generating vehicle 100b. The vibration generating vehicle 100b illustrated in FIG. 2 is an example of the vibration generating vehicle 100 illustrated in FIG. 1. A vibration generation unit 201 to a vibration generation unit sensor 212 of the vibration generating vehicle 100b illustrated in FIG. 5 are the same as the vibration generation unit 201 to the vibration generation unit sensor 212 of the vibration generating vehicle 100a described with reference to FIG. 2, and thus the same reference numerals will be assigned thereto and a description will be omitted. However, information stored in the storage unit 209 and processing of the processing unit 210 are different from those of the vibration generating vehicle 100a described with reference to FIG. 2.

In addition, the vibration generating vehicle 100b includes a relative location sensor 501 and an analysis unit 502 that analyzes information of the relative location sensor 501. For example, the relative location sensor 501 obtains information for calculating a relative location with respect to the preceding vehicle using radar, millimeter wave radar, laser, a camera, etc. The relative location may include a lateral deviation from the preceding vehicle with respect to a traveling direction in addition to an interval from the preceding vehicle. In addition, the relative location sensor 501 may obtain information for calculating a relative location with respect to the subsequent vehicle, and the vibration generating vehicle 100b may include two relative location sensors 501 that obtain information for calculating each of the relative location with respect to the preceding vehicle and the relative location with respect to the subsequent vehicle.

Each of the preceding vehicle and the subsequent vehicle may include a reflector or a mark having a predetermined shape at a rear or a front of the vehicle in a predetermined arrangement such that the relative location sensor 501 may easily obtain the information for calculating the relative location. The analysis unit 502 calculates a relative location based on a positional relationship of the reflector and the mark, a time taken for a reflected wave of the radar or the laser to return, etc. and transmits information about the calculated relative location to the processing unit 210. A general relative location detection technology using a stereo camera may be applied to the analysis unit 502, and a relative location detection technology using a monocular camera may be used.

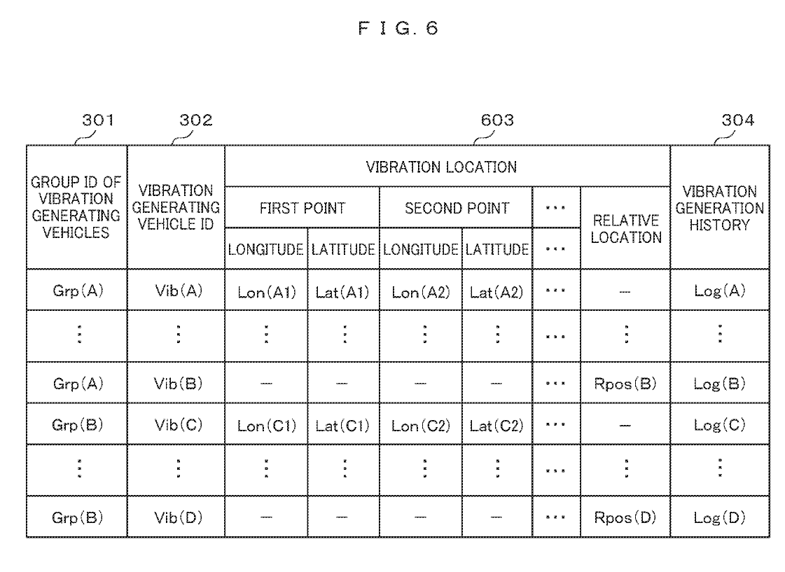

FIG. 6 is a diagram illustrating an example of a vibration generation management table. As described in Embodiment 1 to Embodiment 3, the vibration generation management table may be stored in a storage unit 209 of the vibration generating vehicle 100b or stored in a storage unit of a representative vibration generating vehicle 100b, or a management device other than the vibration generating vehicle 100b may have the vibration generation management table. A group ID of vibration generating vehicles 301, a vibration generating vehicle ID 302, and a vibration generation history 304 of the vibration generation management table illustrated in FIG. 6 are the same as the group ID of vibration generating vehicles 301, the vibration generating vehicle ID 302, and the vibration generation history 304 of the vibration generation management table described with reference to FIG. 3, respectively. Thus, the same reference numerals will be assigned thereto, and a description will be omitted.

Information about longitude and latitude at a location 603 is the same as the information about the longitude and the latitude at the vibration location 303. However, the location 603 additionally includes information about a relative location. The information about the relative location corresponds to information about an interval from a preceding vehicle or a subsequent vehicle. However, the information about the relative location may include a lateral deviation from the preceding vehicle or the subsequent vehicle with respect to a traveling direction or information about an error of the interval or the lateral deviation. At the location 603, the information about the relative location may be set according to each piece of information of the vibration generating vehicle ID 302. Alternatively, when a plurality of vibration generating vehicles 100b has the same relative location, the information may be set in a unit of the plurality of vibration generating vehicles 100b having the same relative location.

In the example illustrated in FIG. 6, a vibration generating vehicle 100b whose vibration generating vehicle ID 302 corresponds to “Vib(A)” includes information about longitude and latitude corresponding to an absolute location of the location 603 and does not include information in a relative location, and a vibration generating vehicle 100b whose vibration generating vehicle ID 302 corresponds to “Vib(B)” does not include information about longitude and latitude corresponding to an absolute location of the location 603 and includes information in a relative location. In this way, information corresponding to one of the absolute location and the relative location may be included in the location 603.

In this configuration, the vibration generating vehicle 100b whose vibration generating vehicle ID 302 corresponds to “Vib(A)” may include a GPS processing unit 207 which is expensive and has less positional error, and the vibration generating vehicle 100b whose vibration generating vehicle ID 302 corresponds to “Vib(B)” may include a GPS processing unit 207 which is inexpensive.

In addition, when the location 603 includes information about an absolute location only at a second point and includes information about a relative location, the information about the absolute location has priority over the information about the relative location at the second point having the information about the absolute location, and an obstacle, etc. is present in the relative location at the second point, the information about the absolute location may be set such that the obstacle is avoided.

A vibration generating vehicle 100b having information about an absolute location set at the location 603 of the vibration generation management table performs the vibration generating vehicle control described with reference to FIG. 4 in Embodiments 1 to 3. A processing unit 210 of a vibration generating vehicle 100b having information about a relative location set at the location 603 of the vibration generation management table obtains the information about the relative location at the location 603 of the vibration generation management table from the storage unit 209 or the communication unit 208 in step 402 described with reference to FIG. 4, and instructs the drive control unit 206 while making a comparison with information about a relative location obtained from the analysis unit 502 in step 403.

In a case in which the information about the relative location is the same regardless of the point of vibration 102, when it is determined that the operation has not ended in step 406, the operation may return to step 403 to use the information about the relative location previously obtained in step 402.

A vibration generating vehicle 100b controlled only by information about a relative location may not include the GPS processing unit 207. In addition, the vibration generating vehicle 100b may correspond to an unmanned vehicle without including the manual operation unit 205. The relative location sensor 501 may not use reflection, and one vibration generating vehicle 100b may emit light or perform transmission to another vibration generating vehicle 100b.

In addition, the relative location sensor 501 may be included on a side surface of the vibration generating vehicle 100b with respect to a traveling direction of the vibration generating vehicle 100b. In the case of a plurality of rows as in the group of vibration generating vehicles 101c described with reference to FIG. 1, a relative location with reference to a vibration generating vehicle 100 located by the side may be detected by the relative location sensor 501. In addition, a relation location at the location 603 of the vibration generation management table described with reference to FIG. 6 may include a value of a relative location of a side surface.

As described above, since the group of vibration generating vehicles 101 includes the plurality of vibration generating vehicles 100, it is possible to include a vibration generating vehicle 100b using a relative location in the group of vibration generating vehicles 101. Further, the vibration generating vehicle 100b using the relative location may be disposed at the point of vibration 102 similarly to the vibration generating vehicle 100a using the absolute location. In addition, since the relative location sensor 501 generally has higher positioning accuracy than that of a GPS at an absolute location, it is possible to improve accuracy of synthesizing vibration energies of a plurality of vibration generating vehicles 100b.

### Embodiment 5

In Embodiments 1 to 4, a description has been mainly given of an example of arrangement of the vibration generating vehicle 100 in one group of vibration generating vehicles 101. In Embodiment 5, a description will be given of an example of vibration generation control of a plurality of groups of vibration generating vehicles 101. Since an exploration target area is wide as described with reference to FIG. 1, for example, vibration is generated by a plurality of groups of vibration generating vehicles 101 including a group of vibration generating vehicles 101a and a group of vibration generating vehicles 101b. However, when a distance between the group of vibration generating vehicles 101a and the group of vibration generating vehicles 101b is insufficient, vibration generation of the group of vibration generating vehicles 101a may interfere with the vibration generation of the group of vibration generating vehicles 101b. Thus, timing of vibration generation of each of the groups of vibration generating vehicles 101 is controlled.

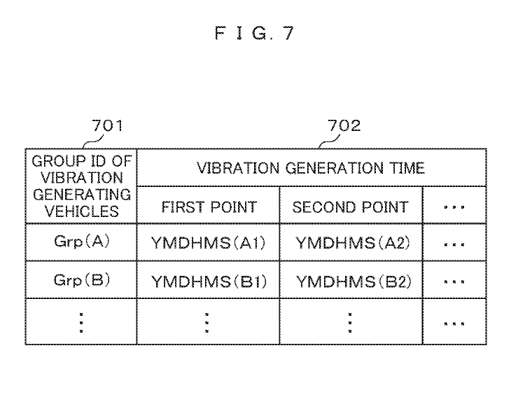

FIG. 7 is a diagram illustrating an example of a vibration generation schedule table. A group ID of vibration generating vehicles 701 corresponding to information for identifying the group of vibration generating vehicles 101 and a vibration generation time 702 corresponding to a time at which vibration is generated at each of a plurality of points of vibration 102 are included. Information about the group ID of vibration generating vehicles 701 corresponds to information about the group ID of vibration generating vehicles 301 of the vibration generation management table. Information about the vibration generation time 702 may correspond to year, month, day, hour, minute, and second. For example, “YMDHMS(A1)” and “YMDHMS(B1)” may correspond to information of different years, months, days, hours, minutes, and seconds.

The vibration generation schedule table may be stored in a storage unit 209 of each vibration generating vehicle 100, stored in a storage unit 209 of a representative vibration generating vehicle 100, or included in a management device (not illustrated). In addition, in a configuration in which the vibration generation schedule table is stored in the storage unit 209 of the vibration generating vehicle 100, information about a group of vibration generating vehicles 101 other than a group of vibration generating vehicles 101 to which the vibration generating vehicle 100 including the storage unit 209 storing the vibration generation schedule table belongs may not be included, and information about the group ID of vibration generating vehicles 701 may not be included.

In a configuration in which the vibration generation schedule table is stored in the storage unit 209 of each vibration generating vehicle 100, in step 404 described with reference to FIG. 4, a processing unit 210 compares information about the vibration generation time 702 obtained from the storage unit 209 with information about a clock unit (not illustrated), and instructs a vibration generation control unit 211 when it is determined that the information matches time. In a configuration in which the vibration generation schedule table is stored in the storage unit 209 of the representative vibration generating vehicle 100, a processing unit 210 of the representative vibration generating vehicle 100 compares information about the vibration generation time 702 obtained from the storage unit 209 with information about a clock unit (not illustrated), instructs a vibration generation control unit 211 when it is determined that the information matches time, and transmits a vibration generation instruction to another vibration generating vehicle 100 through a communication unit 208.

In a configuration in which the management device has the vibration generation schedule table, the management device determines that a current time matches information about the vibration generation time 702 as a time, and transmits a vibration generation instruction to a group of vibration generating vehicles 101 identified by a matching group ID of vibration generating vehicles 701.

In addition, it is possible to adopt a configuration or a flow in which after a location and a state of each group of vibration generating vehicles, for example, whether each group is moving, generating vibration, or in a state allowed to generate vibration is transmitted to an object that detects, manages, and executes an entire vibration generation operation such as a base camp, an observation vehicle 106, etc., and the object detects the entire condition, a vibration generation instruction is issued to the group of vibration generating vehicles such that the operation may be efficiently performed with less mutual interference in data obtainment. Alternatively, it is possible to adopt a configuration or a flow in which vibration generation timing is adjusted by exchanging the information in the group of vibration generating vehicles.

As described above, even when a plurality of groups of vibration generating vehicles 101 generates vibration, it is possible to shift vibration generation timing of each group of vibration generating vehicles 101, and it is possible to use the plurality of groups of vibration generating vehicles 101. In addition, when a group of vibration generating vehicles 101 moves, another group of vibration generating vehicles 101 may generate vibration. Further, it is possible to shorten exploration time using the plurality of groups of vibration generating vehicles 101.

### Embodiment 6

In Embodiments 1 to 5, a description has been given of an example of arrangement of the vibration generating vehicle 100 at the point of vibration 102 and vibration generation timing. In Embodiment 6, a description will be given of an example of control of movement between two points of vibration 102. In the vibration generating vehicle 100b described with reference to FIG. 5, the relative location sensor 501 is included, and the drive control unit 206 is controlled such that the relative location with respect to the preceding vehicle or the subsequent vehicle matches the information about the relative location at the location 603 within the range of the error. Thus, when a vehicle stops after movement in step 403, a stop location thereof corresponds to a point of vibration 102.

In control of a vibration generating vehicle 100b based on a relative location during movement, for example, when a vibration generating vehicle 100 corresponding to a reference vehicle of the relative location is moved to the right or the left by a driver operating a driving wheel to avoid an obstacle during movement, the vehicle moves to the right or the left while maintaining the relative location even at a point at which the obstacle is not reached, and a path becomes different from a path of the vibration generating vehicle 100 corresponding to the reference vehicle of the relative location. Therefore, it is possible to adopt path copy control for obtaining the same path as the path of the vibration generating vehicle 100 corresponding to the reference vehicle of the relative location. The path of the vibration generating vehicle 100 corresponding to the reference vehicle may be detected by a relative location sensor 501.

In addition, since a drive control unit 206 controls a direction of a tire, etc. based on an instruction from a processing unit 210 and information from a manual operation unit 205, it is possible to assist in an operation of the manual operation unit 205 by the driver using the instruction from the processing unit 210. For example, when the driver removes hands from a driving wheel of the manual operation unit 205, and thus information from the manual operation unit 205 is not present, there is no information even when the information from the manual operation unit 205 has priority. Thus, the direction of the tire, etc. may be controlled based on the instruction from the processing unit 210.

Further, upon determining that a vibration generating vehicle 100 is closer to another vibration generating vehicle 100 than a preset distance based on information about the relative location, the processing unit 210 may block the information from the manual operation unit 205 and instruct the drive control unit 206 to perform a control operation such that a distance between the vibration generating vehicle 100 and the other vibration generating vehicle 100 is increased. When a plurality of rows of vibration generating vehicles 100 run in parallel as the group of vibration generating vehicles 101c described with reference to FIG. 1, it is possible to use information about a relative location by the relative location sensor 501 on a side surface of the vibration generating vehicle 100b. It is possible to perform a control operation such that front and rear positions of respective rows of the group of vibration generating vehicles 101c are aligned.

Conversely, when the vibration generating vehicle moves based only on an absolute location or relative location, an obstacle, etc. on the path may not be avoided. Therefore, when the driver put the hands on the driving wheel of the manual operation unit 205 and performs an obstacle avoidance operation, the drive control unit 206 may control the direction of the tire, etc. based on information from the manual operation unit 205 having priority.

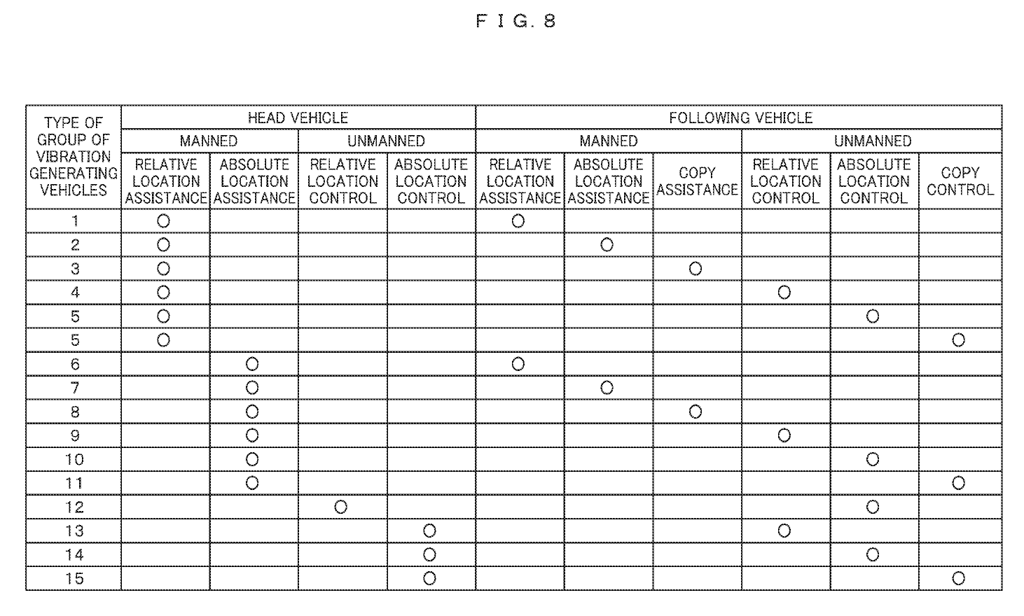

FIG. 8 is a diagram illustrating an example of a type of group of vibration generating vehicles. Depending on whether each of a head vehicle and a following vehicle is manned or not, a relative location, an absolute location, and copy are controlled or assisted. In the example illustrated in FIG. 8, when the type of group of vibration generating vehicles corresponds to “1”, the head vehicle is manned and subjected to relative location assistance, and the following vehicle is manned and subjected to relative location assistance.

When the head vehicle is unmanned and subjected to relative location control, the type of group of vibration generating vehicles corresponds to “12” in which the following vehicle is unmanned and subjected to absolute location control, and the head vehicle is controlled to maintain the relative location with respect to the following vehicle. Such a type of group of vibration generating vehicles is obtained since a location may not be specified when the following vehicle is unmanned and subjected to relative location control or copy control. Further, even when the following vehicle is manned, an obstacle located in front of the head vehicle is hardly visually checked and the obstacle may not be avoided particularly in copy assistance. However, when the head vehicle is unmanned and subjected to relative location control or absolute location control, the following vehicle may not be unmanned, and the following vehicle may be manned.

When the head vehicle is unmanned and subjected to absolute location control, and the following vehicle is unmanned and subjected to absolute location control, the type of group of vibration generating vehicles corresponds to “14”. In this case, all vibration generating vehicles 100 perform independent travel, and thus each of the vibration generating vehicles 100 further includes map information of a movement path 104, and paths which do not interfere with each other, for example, a plurality of types of paths may be set as the movement path 104.

Whether the vehicle is manned or unmanned and whether a relative location, an absolute location, or copy is related corresponding to a base of the type of group of vibration generating vehicles may be selectable from an input device (not illustrated). Since the vibration generating vehicle 100a described with reference to FIG. 2 does not include the relative location sensor 501, only absolute location control or absolute location assistance may be selectable based on information storing a vehicle type corresponding to the vibration generating vehicle 100a. In addition, only “unmanned” may be selectable based on information storing a vehicle type corresponding to a vibration generating vehicle 100 not including the manual operation unit 205.

When only one vibration generating vehicle 100 uses an absolute location and another vibration generating vehicle 100 uses a relative location in the group of vibration generating vehicles 101, only a GPS processing unit 207 of the vibration generating vehicle 100 using the absolute location may be expensive and highly accurate. Further, a GPS processing unit 207 of the other vibration generating vehicle 100 may be inexpensive and simple.

As described above, it is possible to select the head vehicle and the following vehicle according to a geographical situation of an exploration target area, a deployment situation of the driver, a vehicle type of the vibration generating vehicle 100, etc. Further, safety of movement may be ensured by a relative location or copy, and burden on the driver during movement may be reduced by assistance.

In addition, when a positional relationship of the point of vibration 102 is maintained with respect to the vibration generating vehicle 100 during movement by a relative location or copy, all vibration generating vehicles 100 of the group of vibration generating vehicles 101 may be stopped and disposed at points of vibration 102 at the same time, and thus it is possible to shorten time from movement to vibration generation.

### Embodiment 7

In Embodiment 6, a description has been given of an example of control of movement of the vibration generating vehicle 100 between points of vibration 102. However, as described with reference to FIG. 1, at the point of vibration 102 of the movement path 104a, the vibration generating vehicle 100 makes a U-turn to proceed to the movement path 104b, and thus a description will be given of an example of control of the U-turn. When the vibration generating vehicle 100 makes a U-turn, it is presumed that detection of a relative location is relatively difficult unlike a series of vibration generating actions centered on linear travel.

Therefore, information about an absolute location of the U-turn is included in the vibration generation management table described with reference to FIG. 3 or FIG. 6 to perform a control operation such that speed is reduced at the time of approaching a preset distance from the absolute location of the U-turn and speed is increased at the time of moving away from the preset distance from the absolute location of the U-turn. In addition, a direction of a tire may be controlled to make a U-turn of a preset radius by detecting a situation at a location requiring the U-turn.

To this end, in a case in which a relative location is controlled or assisted, control or assistance of the relative location may be released at the time of approaching the preset distance from the absolute location of the U-turn, and control or assistance of the relative location may be made effective at the time of moving away from the preset distance from the absolute location of the U-turn.

As described above, the vibration generating vehicle 100 may travel in an unsteady manner according to the movement path 104 of the exploration target area. In particular, when information about a location of unsteady travel is additionally included in the vibration generation management table, management may be performed similarly to the point of vibration 102. In addition, in the case of unsteady travel such as the U-turn, even though there is a possibility that a relative location may not be correctly detected, it is possible to perform a control operation by suppressing an influence of the relative location.

### Embodiment 8

In Embodiments 1 to 7, a description has been given of an example of movement to the point of vibration 102, arrangement, and vibration generation timing of the vibration generating vehicle 100. In Embodiment 8, a description will be given of an example of maintenance of a vibration generating vehicle 100. The vibration generating vehicle 100 is used in a harsh environment such as a desert in many cases. When the vibration generating vehicle 100 may not be operated due to failure, etc., an influence on an exploration schedule is great, and thus preliminary maintenance is important.

Load applied to a vibration generation unit 201 greatly varies depending on the soil on a ground surface to be vibrated. Since a temperature difference between daytime and nighttime is large in a desert, and humidity becomes high when the ocean is near, when a maintenance time is merely determined based only on an elapsed time, there is a possibility that failure may occur before maintenance. It is possible to use information detected by a vibration generation unit sensor 212 and an environmental sensor 213 and stored in a storage unit 209 as a vibration generation history 304 of a vibration generation management table.

For example, when a vehicle relationship of an engine, a tire, etc. or information indicating that an influence on the vibration generation unit 201 is great is stored as the vibration generation history 304, indication diagnosis may be performed. For example, a state may be checked faster than usual, or a part may be replaced. In addition, as a combination of vibration generating vehicles 100 included in a group of vibration generating vehicles 101, a vibration generating vehicle 100 having large vibration detected by the vibration generation unit sensor 212 and a vibration generating vehicle 100 having small vibration detected by the vibration generation unit sensor 212 may be combined to generate predetermined vibration energy as the group of vibration generating vehicles 101. In this way, the vibration generating vehicles 100 included in the group of vibration generating vehicles 101 may be determined based on the vibration generation history 304 and managed by the vibration generation management table.

Information corresponding to the vibration generation history 304 of the vibration generation management table may be transmitted through a communication unit 208 each time step 405 is executed, and states of the vibration generating vehicles 100 may be remotely monitored.

As described above, it is possible to perform maintenance depending on the state of each of the vibration generating vehicles 100, and to assist in deploying the vibration generating vehicles 100 in the group of vibration generating vehicles 101.

### Embodiment 9

In Embodiments 1 to 8, a description has been given of an example of wireless communication using the communication unit 208 as communication between the vibration generating vehicles 100. In Embodiment 9, a description will be given of an example in which two vibration generating vehicles 100 are connected by wire. Since wireless communication is subjected to a radio raw of each country, it is preferable not to use wireless communication in some cases. In addition, since wireless communication may have a reliability problem or be delayed, a wire is preferably applied in some cases.

Therefore, for example, in a group of vibration generating vehicles 101, only one vibration generating vehicle 100 may include a wireless communication unit 208, and the other vibration generating vehicle 100 may not include the wireless communication unit 208 and may be connected to preceding and subsequent vibration generating vehicles 100 by wire. A wire may correspond to a general wired network cable, and communication with the outside of the group of vibration generating vehicles 101 may be performed through the vibration generating vehicle 100 including the wireless communication unit 208.

A processing unit 210 may control a drive control unit 260 based on a distance from a preceding or subsequent vibration generating vehicle 100 detected by a relative location sensor 501 and analyzed by an analysis unit 502 and a length of a wire. For example, the drive control unit 206 may be controlled such that the distance from the vibration generating vehicle 100 is not greater than or equal to the length of the wire, and the drive control unit 206 may be controlled such that the wire does not touch a ground surface by loosening. In addition, a wired tension sensor may be included in a wired connection part of the vibration generating vehicle 100, and the processing unit 210 may control the drive control unit 206 such that magnitude of tension detected by the tension sensor or a direction in which tension is generated falls within a preset range.

As described above, communication between vibration generating vehicles 100 may be ensured even in an area in which radio regulation is severe. In addition, a wire may be used to detect a relative location.

Each of the embodiments described above is not limited to each embodiment, and a part of a configuration described in each embodiment may be added to another embodiment or replaced. In addition, a part of a configuration described in each embodiment may be omitted. Further, each unit of the vibration generating vehicle 100 may include hardware such as a circuit, include hardware such as a machine, or be configured by a processor executing a program.

### REFERENCE SIGNS LIST

100 vibration generating vehicle

101 group of vibration generating vehicles

102 point of vibration

103 sensor

104 movement path

105 satellite

106 observation vehicle

1. An exploration system comprising
a plurality of vibration generating vehicles, wherein
resource exploration is performed by a vibration generation by a group of vibration generating vehicles including the plurality of vibration generating vehicles, and
each of the plurality of vibration generating vehicles of the group of vibration generating vehicles includes
a storage unit in which vibration location information related to a vibration location in a vibration by the group of vibration generating vehicles is stored in association with the group of vibration generating vehicles,
an exploration unit that performs a vibration generating action for exploration,
a control unit that controls movement of the vibration generating vehicles, and
a processing unit that obtains the vibration location information from the storage unit, instructs the control unit to move based on the obtained vibration location information, and instructs the exploration unit to perform the vibration generating action after movement to the vibration location.

2. The exploration system according to claim 1, wherein
a first vibration generating vehicle in the group of vibration generating vehicles further includes
a first location detection unit that detects an absolute location,
vibration location information of the absolute location is stored in a storage unit of the first vibration generating vehicle,
a processing unit of the first vibration generating vehicle obtains the vibration location information of the absolute location from the storage unit of the first vibration generating vehicle, and instructs a control unit of the first vibration generating vehicle to move based on the obtained vibration location information of the absolute location and the absolute location detected by the first location detection unit,
a second vibration generating vehicle in the group of vibration generating vehicles further includes
a second location detection unit that detects a relative location with respect to the first vibration generating vehicle,
vibration location information of the relative location is stored in a storage unit of the second vibration generating vehicle, and
a processing unit of the second vibration generating vehicle obtains the vibration location information of the relative location from the storage unit of the second vibration generating vehicle, and instructs a control unit of the second vibration generating vehicle to move based on the obtained vibration location information of the relative location and the relative location detected by the second location detection unit.

3. The exploration system according to claim 2, wherein
the first vibration generating vehicle
moves in front of the second vibration generating vehicle, and
further includes an operation unit manually operated to transmit an operation to the control unit of the first vibration generating vehicle, and
the control unit of the first vibration generating vehicle controls movement of the vibration generating vehicle by giving priority to an operation of the operation unit of the first vibration generating vehicle over an instruction of the processing unit of the first vibration generating vehicle.

4. The exploration system according to claim 2, wherein
the second vibration generating vehicle
moves behind the first vibration generating vehicle, and
further includes an operation unit manually operated to transmit an operation to the control unit of the second vibration generating vehicle, and
the control unit of the second vibration generating vehicle controls movement of the vibration generating vehicle by giving priority to an instruction of the processing unit of the second vibration generating vehicle over an operation of the operation unit of the second vibration generating vehicle.

5. The exploration system according to claim 4, wherein
the second location detection unit detects a distance from the first vibration generating vehicle as a relative location with respect to the first vibration generating vehicle, and
the processing unit of the second vibration generating vehicle obtains a distance from the first vibration generating vehicle as vibration location information of a relative location from the storage unit of the second vibration generating vehicle, and instructs the control unit of the second vibration generating vehicle to move such that the obtained distance and the distance detected by the second location detection unit fall within preset errors.

6. An exploration system comprising
a plurality of vibration generating vehicles, wherein
resource exploration is performed by a vibration generation by a group of vibration generating vehicles including the plurality of vibration generating vehicles,
a first vibration generating vehicle in the group of vibration generating vehicles includes
a storage unit that stores first vibration location information related to a vibration location at a time of vibration generation by the group of vibration generating vehicles and second vibration location information associated with the group of vibration generating vehicles,
a first communication unit that communicates with the plurality of vibration generating vehicles,
a first exploration unit that performs a vibration generating action for exploration,
a first control unit that controls movement of the vibration generating vehicle, and
a first processing unit that obtains the first vibration location information and the second vibration location information from the storage unit, transmits the obtained second vibration location information from the first communication unit, instructs the first control unit to move based on the obtained first vibration location information, and instructs the first exploration unit to perform a vibration generating action after movement, and
a second vibration generating vehicle in the group of vibration generating vehicles includes
a second communication unit that communicates with the first vibration generating vehicle,
a second exploration unit that performs a vibration generating action for exploration,
a second control unit that controls movement of the vibration generating vehicle, and
a second processing unit that obtains second vibration location information received by the second communication unit, instructs the second control unit to move based on the obtained second vibration location information, and instructs the second exploration unit to perform a vibration generating action after movement.

7. The exploration system according to claim 6, wherein
the first vibration generating vehicle further includes
a first location detection unit that detects an absolute location,
first vibration location information of an absolute location and second vibration location information of a relative location are stored in the storage unit,
the first processing unit obtains the first vibration location information and the second vibration location information from the storage unit, transmits the obtained second vibration location information from the first communication unit, and instructs the first control unit to move based on the obtained first vibration location information and the absolute location detected by the first location detection unit,
the second vibration generating vehicle further includes
a second location detection unit that detects a relative location with respect to the first vibration generating vehicle, and
the second processing unit obtains second vibration location information received by the second communication unit, and instructs the second control unit to move based on the obtained second vibration location information and the relative location detected by the second location detection unit.

8. The exploration system according to claim 7, wherein
the first vibration generating vehicle
moves in front of the second vibration generating vehicle, and
further includes a first operation unit manually operated to transmit an operation to the first control unit, and
the first control unit controls movement of the vibration generating vehicle by giving priority to an operation of the first operation unit over an instruction of the first processing unit.

9. The exploration system according to claim 7, wherein
the second vibration generating vehicle
moves behind the first vibration generating vehicle, and
further includes a second operation unit manually operated to transmit an operation to the second control unit, and
the second control unit controls movement of the vibration generating vehicle by giving priority to an instruction of the second processing unit over an operation of the second operation unit.

10. The exploration system according to claim 9, wherein
the second location detection unit detects a distance from the first vibration generating vehicle as a relative location with respect to the first vibration generating vehicle, and
the second processing unit obtains a distance from the first vibration generating vehicle received by the second communication unit as second vibration location information, and instructs the second control unit to move such that the obtained distance and the distance detected by the second location detection unit fall within preset errors.

11. An exploration system comprising:
a management device; and
a plurality of vibration generating vehicles, wherein
resource exploration is performed by a vibration generation by a group of vibration generating vehicles including the plurality of vibration generating vehicles,
the management device
has a plurality of vibration location information items related to vibration locations at a time of vibration generation by the group of vibration generating vehicles stored in association with the group of vibration generating vehicles, and transmits each of the plurality of vibration location information items, and
each of the plurality of vibration generating vehicles of the group of vibration generating vehicles includes
a communication unit that communicates with the management device,
an exploration unit that performs a vibration generating action for exploration,
a control unit that controls movement of each of the vibration generating vehicles, and
a processing unit that obtains vibration location information received from the management device by the communication unit, instructs the control unit to move based on the obtained vibration location information, and instructs the exploration unit to perform a vibration generating action after movement.

12. The exploration system according to claim 11, wherein
the management device
has vibration location information of an absolute location and vibration location information of relative location as the plurality of vibration location information items stored in association with the group of vibration generating vehicles, and transmits the vibration location information of the absolute location and the vibration location information of the relative location,
a first vibration generating vehicle among the plurality of vibration generating vehicles in the group of vibration generating vehicles further includes
a first location detection unit that detects an absolute location,
a processing unit of the first vibration generating vehicle obtains vibration location information of an absolute location received by a communication unit of the first vibration generating vehicle, and instructs a control unit of the first vibration generating vehicle to move based on the obtained vibration location information of the absolute location and the absolute location detected by the first location detection unit,
a second vibration generating vehicle among the plurality of vibration generating vehicles further includes
a second location detection unit that detects a relative location with respect to the first vibration generating vehicle, and
a processing unit of the second vibration generating vehicle obtains vibration location information of a relative location received by a communication unit of the second vibration generating vehicle, and instructs a control unit of the second vibration generating vehicle to move based on the obtained vibration location information of the relative location and the relative location detected by the second location detection unit.

13. The exploration system according to claim 12, wherein
the first vibration generating vehicle
moves in front of the second vibration generating vehicle, and
further includes an operation unit manually operated to transmit an operation to the control unit of the first vibration generating vehicle, and
the control unit of the first vibration generating vehicle controls movement of the vibration generating vehicle by giving priority to an operation of the operation unit of the first vibration generating vehicle over an instruction of the processing unit of the first vibration generating vehicle.

14. The exploration system according to claim 12, wherein
the second vibration generating vehicle
moves behind the first vibration generating vehicle, and
further includes an operation unit manually operated to transmit an operation to the control unit of the second vibration generating vehicle, and
the control unit of the second vibration generating vehicle controls movement of the vibration generating vehicle by giving priority to an instruction of the processing unit of the second vibration generating vehicle over an operation of the operation unit of the second vibration generating vehicle.

15. The exploration system according to claim 14, wherein
the second location detection unit detects a distance from the first vibration generating vehicle as a relative location with respect to the first vibration generating vehicle, and
the processing unit of the second vibration generating vehicle obtains a distance from the first vibration generating vehicle received by the communication unit of the second vibration generating vehicle as vibration location information of a relative location, and instructs the control unit of the second vibration generating vehicle to move such that the obtained distance and the distance detected by the second location detection unit fall within preset errors.
